(19) United States
(12) Patent Application Publication
(10) Pub. No.: US 2014/0274348 A1
(43) Pub. Date: Sep. 18, 2014

(54) SYSTEMS, METHODS, AND DEVICES FOR PLAYING WAGERING GAMES WITH RANDOMIZED AWARD MULTIPLIERS BASED ON WAGER LEVEL

(71) Applicant: WMS Gaming Inc., Waukegan, IL (US)

(72) Inventor: Anthony Baerlocher, Henderson, NV (US)

(73) Assignee: WMS Gaming Inc., Waukegan, IL (US)

(21) Appl. No.: 14/209,599

(22) Filed: Mar. 13, 2014

Related U.S. Application Data
(60) Provisional application No. 61/787,355, filed on Mar. 15, 2013.

(51) Int. Cl. G07F 17/32

(52) U.S. Cl. CPC G07F 17/3267
USPC 463/26

(57) ABSTRACT

Gaming devices, gaming systems, methods of conducting wagering games, and computer programs for executing wagering games are disclosed. Computer-implemented methods of executing a wagering game are disclosed herein. For some implementations which utilize paylines in determining a winning outcome, the method incorporates a non-linear escalation of payline multipliers based on a player's wager level. The wager level determines which of a plurality of “multiplier pools” the player will be entered into for a particular play of the wagering game. A minimum multiplier for each pool is at least the standard payline multiplier (e.g., at wager level 2, the minimum multiplier is 2×), though at higher wager levels the minimum multiplier in the corresponding pool may be higher than the standard minimum payline multiplier (e.g., at wager level 4, the minimum multiplier is 5× instead of just 4×).

### CLAIM OF PRIORITY AND CROSS-REFERENCE TO RELATED APPLICATION

This application claims the benefit of priority to U.S. Provisional Patent Application No. 61/787,355, which was filed on Mar. 15, 2013, and is incorporated herein by reference in its entirety.

### COPYRIGHT

A portion of the disclosure of this patent document contains materials which are subject to copyright protection. The copyright owner has no objection to the facsimile reproduction by anyone of the patent disclosure as it appears in the U.S. Patent and Trademark Office patent files or records, but otherwise reserves all copyright rights whatsoever.

### TECHNICAL FIELD

The present disclosure relates generally to wagering games, as well as wagering game devices and gaming systems, and methods for playing wagering games. More particularly, aspects of the present disclosure relate to systems, methods, and devices for playing wagering games with award multipliers.

### BACKGROUND

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Thus, gaming manufacturers continuously endeavor to develop new games and improved gaming enhancements that will attract frequent play and player loyalty through enhanced entertainment value to the player.

One concept that has been successfully employed to enhance the entertainment value of a game is the concept of a “secondary” or “bonus” game that may be played in conjunction with a “primary” or “basic” game. The bonus game may comprise any type of game, either similar to or completely different from the basic game, which is entered upon the occurrence of a selected event or outcome during play of the basic game. Generally, bonus games provide a greater expectation of winning than the basic game and may also be accompanied with more attractive or unusual video displays and/or audio.

Another concept that has been employed is the use of progressive jackpots. In the gaming industry, a “progressive jackpot” involves collecting coin-in data from participating gaming device(s), such as slot machines, contributing a percentage of that coin-in data to a jackpot amount, and awarding that jackpot amount to a player upon the occurrence of a jackpot-winning event. A jackpot-winning event typically occurs when a “progressive winning position” is achieved at a participating gaming device. If the gaming device is a slot machine, a progressive winning position may, for example, correspond to alignment of progressive jackpot reel symbols along an active payline. The initial progressive jackpot is a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate.

In traditional wagering games with movable symbol-bearing reels, such as mechanical, electromechanical and video slot machines, one or more paylines are utilized to determine whether a play of the slot game includes any winning symbol combinations (typically referred to as “payline wins” or “line pays”). These paylines typically traverse a display region overlying the movable reels, extending horizontally across the symbols borne by the slot reels. After spinning and stopping the reels, the symbol combinations that are present along the paylines are used for indicating the outcome of the game. Line pays typically occur when any of a variety of predetermined types and numbers of symbols (e.g., as indicated in a pay table) appear on an activated payline, aligned left-to-right along the payline in the display region.

In the past, the amount a player wagered directly determined what the payline multiplier would be for a particular play of the slot game. Specifically, a player wagering only a single credit (“wager level 1”) would receive a payout of 1× the award value of a particular winning symbol combination for achieving a particular payline win, while a player wagering five credits (“wager level 5”) would receive 5× the award value of the winning symbol combination for that same payline win. In some game configurations, certain awards also received an increased “kicker” pay if the player placed a maximum wagering (e.g., a royal flush pays a 1×-award of 250 credits for a single-credit wager, a 2×-award of 500 credits for a two-credit wager, a 3×-award of 750 credits for a three-credit wager, and a 4×-award of 1000 credits for a four-credit wager, but an enhanced award of 2500 credits for a five-credit maximum wager). Some game configurations offer an additional award multiplier that is awarded in the wagering game outcome on top of the standard payline multipliers.

One advancement in this area has been the addition of more paylines, which are typically arranged in straight and zigzag configurations across the display region. Other advancements include atypical payline evaluations, including pay schemes where symbol combinations are evaluated right-to-left, atypical payline configurations, where paylines start and finish on central reel positions, and dynamic paylines, where a payline is randomly activated by a gaming controller to increase the number of winning payouts. While these advancements have created enhanced excitement for the player, there may be an existing need to create additional player excitement and entertainment by adding new features to paylines and award multipliers.

### SUMMARY

Aspects of the present disclosure are directed to gaming devices, gaming systems, methods of conducting wagering games, and computer programs for executing wagering games with a non-linear escalation of award multipliers based on a player's wager level. The wager level risked by a player determines which of a plurality of “multiplier pools” the player will be entered into for a particular play of the wagering game. Once the wager level and multiplier pool are identified, the award multiplier is randomly selected from the corresponding pool. For some implementations, a minimum multiplier for each pool is at least the standard payline multiplier (e.g., at wager level 1, the minimum available multiplier is 1×, at wager level 2, the minimum available multiplier is 2×, and so on). Optionally, at higher wager levels, the minimum available multiplier in the corresponding pool may be higher than the standard minimum payline multiplier (e.g., at wager level 4, the minimum multiplier is 5× instead of 4×).

According to one aspect of the present disclosure, a gaming system for conducting a wagering game is disclosed. The gaming system includes one or more processors and one or more memory devices. The memory device(s) stores instructions that, when executed by at least one of the one or more processors, cause the gaming system to: receive an indication of a wager to play the wagering game, the wagering game including a plurality of available wager levels, each of the wager levels corresponding to a respective wager amount and a respective multiplier pool, each of the multiplier pools including a plurality of award multipliers; determine, from the available wager levels, a wager level of the received wager; randomly determine, from the respective multiplier pool corresponding to the determined wager level of the received wager, an award multiplier; randomly determine an outcome of the wagering game; and apply the award multiplier to the outcome of the wagering game.

In accordance with another aspect of the disclosure, one or more physical non-transitory machine-readable storage media are featured which include instructions which, when executed by one or more processors, cause the one or more processors to perform operations comprising: receive an indication of a wager to play a wagering game, the wagering game including a plurality of available wager levels, each of the wager levels corresponding to a respective wager amount and a respective multiplier pool, each of the multiplier pools including a plurality of award multipliers; determine, from the available wager levels, a wager level of the received wager; randomly determine, from the respective multiplier pool corresponding to the wager level associated with the received wager, an award multiplier; randomly determine an outcome of the wagering game; and apply the award multiplier to the outcome of the wagering game.

Other aspects of the present disclosure are directed to a method of conducting a wagering game with a gaming system. The gaming system includes one or more input devices, one or more display devices, and one or more processors. The method includes: receiving, via at least one of the one or more input devices, an indication of a wager to play the wagering game, the wagering game including a plurality of available wager levels, each of the wager levels corresponding to a respective wager amount and a respective multiplier pool, each of the multiplier pools including a plurality of award multipliers; determining, from the available wager levels, a wager level of the received wager; randomly determining, via at least one of the one or more processors from the respective multiplier pool corresponding to the wager level associated with the received wager, an award multiplier; randomly determining, via at least one of the one or more processors, an outcome of the wagering game; applying the award multiplier to the outcome of the wagering game; and, displaying, via at least one of the one or more display devices, the randomly determined wagering game outcome.

The above summary is not intended to represent each embodiment or every aspect of the present disclosure. Rather, the summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of an example of a free-standing gaming terminal according to aspects of the present disclosure.

FIG. 2 is a schematic diagram of an example of a gaming system according to aspects of the present disclosure.

FIG. 3 is a screen shot of a representative basic-game screen of a wagering game displayed on a gaming terminal, gaming device, and/or gaming system according to aspects of the present disclosure.

FIG. 4 is front-view illustration of a representative gaming terminal showing a screen shot of a basic-game screen and a screen shot of an award multiplier pool screen from an exemplary wagering game in accordance with aspects of the present disclosure.

FIG. 5 is a chart illustrating some exemplary award multiplier pools and corresponding award multipliers with their corresponding probabilities of selection and payback percentages in accordance with aspects of the present disclosure.

FIG. 6 is a flowchart for an exemplary method or algorithm that can correspond to instructions that can be stored on one or more non-transitory computer-readable media and can be executed by one or more controllers in accord with aspects of the disclosed concepts.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” mean “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Referring to the drawings, wherein like reference numerals refer to like features throughout the several views, there is shown in FIG. 1 a representative gaming terminal 10 similar to those used in gaming establishments, such as casinos, hotels and cruise ships, and non-conventional gaming establishments, such as airports and restaurants. With regard to the present disclosure, the gaming terminal 10 may be any type of gaming terminal and may have varying structures and methods of operation. For example, in some aspects, the gaming terminal 10 is an electromechanical gaming terminal configured to play slots with mechanical reels, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models (as shown), handheld mobile devices, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 B2, U.S. Patent Application Pub. Nos. US 2010/0069160 A1 and US 2010/0234099 A1, and International Application No. PCT/US2007/000792, all of which are incorporated herein by reference in their respective entireties and for all purposes.

The gaming terminal 10 illustrated in FIG. 1 comprises a cabinet 11 that may house various input devices, output devices, and input/output devices. By way of non-limiting example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display may be disposed in front of the mechanical-reel display to portray a video image superimposed upon the mechanical-reel display. The display areas may variously display information associated with wagering games, non-wagering games, community games, progressive games, advertisements, services, premium entertainment, text messaging, emails, alerts, announcements, broadcast information, subscription information, etc., appropriate to the particular mode(s) of operation of the gaming terminal 10. The gaming terminal 10 includes a touch screen(s) 18 mounted over the primary and/or secondary areas 12, 14, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals can be selected from a group consisting essentially of an electrical current, an electrical voltage, an electrical charge, an optical signal, an optical element, a magnetic signal, and a magnetic element.

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes a random number generator (RNG) for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by an RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

Referring now to FIG. 4, an exemplary gaming terminal, designated generally at 510, for playing one or more wagering games is shown in accordance with aspects of the present disclosure. Although differing in appearance, the gaming terminal 510 of FIG. 4 can be similar in function, operation, and connectivity to the gaming terminal 10 discussed above with respect to FIGS. 1 and 2 and, thus, can include any of the options, features and alternatives described above. For example, the gaming terminal 510 (also referred to herein as “wagering game machine” or “gaming machine”) can take on various configurations including, for example, free standing gaming machines, handheld and portable gaming machines, countertop gaming machines, personal computers and laptop computers, smartphones and tablets, or any combination thereof. To that end, the gaming terminal 510 of FIG. 4 may be an electromechanical gaming terminal configured, for example, to play electromechanical slots, or it may be an electronic gaming terminal configured, for example, to play a video casino game, such as keno, poker, slots, blackjack, roulette, or a combination of both.

The illustrated gaming terminal 510 comprises a cabinet 512 for housing and/or supporting a variety of operational componentry (e.g., CPU 42, memory 44, external systems interface 58, etc.). For output devices, the gaming terminal 510 includes, among other things, a primary display area (or “first display device”) 514, a secondary display area (or “second display device”) 516, and a tertiary display area (or “third display device”) 518. Recognizably, one or more of the foregoing display areas/devices can be combined into a single display area/device. For input devices, the gaming terminal 510 may include a bill receiving and validating device, a coin acceptor, a touchscreen, a button panel, one or more information readers, one or more other player input devices, and/or one or more player-accessible ports (e.g., an audio output jack for headphones, a video headset jack, an internet cable jack, a wireless transmitter/receiver, etc.). While these typical components found in the gaming terminal 510 are described above, it should be understood that numerous additional/alternative peripheral devices and other elements may exist and may be used in any number of combinations to create various forms of a gaming terminal.

The primary display device 514 of the gaming terminal 510, which may be part of an exemplary gaming system 500, provides a screen shot of a game screen from an exemplary wagering game in accordance with aspects of the present disclosure. The primary display device 514 of the gaming terminal 510 displays wagering games, such as those described above with respect to FIGS. 1-3 or those described below with respect to FIGS. 4-6, for example. The display devices 514, 518, 518 may be any form of display, such as those described with reference to the free-standing gaming terminal 10 of FIG. 1. For instance, the primary display 514 may comprise a plasma, LED, OLED, AMOLED, LCD, CRT, projection, or any other now-known or later-developed display device. Although numerous aspects of the wagering game 530 are all shown displayed on a single display device, namely the primary display 514, these aspects are not so limited and can be displayed in any combination on any number of display devices unless otherwise expressly prohibited.

The display device 514 displays or otherwise visually depicts a wagering game 530, which in this example is the slot game shown in FIG. 4. The slot game 530 includes a plurality of symbol-bearing reels, designated generally as 535-539 in FIG. 4, each having a plurality of distinct reel positions occupied by a number of symbols (collectively represented by symbols 545-547 in FIG. 4). The reels 535-539 may be electro-mechanical reels, computer-generated simulations of reels, other replicated forms of reels, or any variation thereof. The symbols may include any variety of graphical symbols, emblems, elements, or representations, including symbols that are associated with one or more themes of the gaming terminal 510 and gaming system 500 (e.g., a Greek mythology theme). The symbols may also include a blank symbol or empty space. The symbols on the reels 535-539, when part of a wagering-game outcome, are arranged in an array 532, which in this embodiment is a 3×5 matrix—three rows by five columns—of distinct array positions. The reels 535-539 are varied (e.g., spun and stopped) to reveal combinations of symbols, which represent randomly selected outcomes of the wagering game 530, that are evaluated for winning combinations. Winning combinations of symbols landing, for example, on activated paylines (e.g., those paylines for which a wager has been received) which extend through the array positions, cause awards to be paid in accordance with one or more pay tables associated with the gaming system 500. In some embodiments, winning combinations of symbols include three or more like symbols aligned adjacent one another on an active pay line (e.g., left-to-right configuration, right-to-left configuration, or both). In some embodiments, symbol combinations are evaluated in accord with various other schemes such as, but not limited to, scatter pays.

Within the scope of this disclosure, the wagering game 530 can include greater or fewer than five symbol-bearing reels (simulated, mechanical, or otherwise), each of which may include greater or fewer reel positions than those shown in FIG. 4. In alternate embodiments, the randomly selected outcomes may comprise greater or fewer than 15 symbols, and may take on a variety of different forms having greater or fewer rows and/or columns. The matrix may even comprise other non-rectangular forms or arrangements of symbols. Moreover, the randomly selected outcomes of the wagering game 530 may be varied from the representation provided in FIG. 4. Likewise, the Greek mythology theme is purely illustrative and non-limiting in nature.

The primary display 514 further includes certain display features for providing information and options to a player. For example, these display features may include a MENU/HELP button 580, a WIN meter 582, a CREDITS meter 584, and a BET meter 586. The MENU button 580 can be pressed and activated (e.g., through an overlying touch screen) by a player desiring to access other control menus, preferences, help screens, etc. For example, the player can change a theme of the wagering game 530 via the MENU button 580, or change the type of wagering game being played (e.g., to video poker, keno, etc.). The WIN meter 582 displays to the player the amount of the total win (if any) from the most recent play of the wagering game 530. The CREDITS meter 584 displays to the player the total amount of credits, if any, remaining and available to the player for play of the wagering game 530. The BET meter 586 displays to a player the current size of his/her wager (in credits). Fewer, additional or alternative display features may be included for presenting information/options to a player. The primary display 514 can also include, for example, an optional change-denomination feature 588 that can be activated to change the denomination of wagers (e.g., from $0.25/credit to $0.10/credit) which the player is inputting into the system 500, and bet change buttons 585 and 587 that permit a player to incrementally increase and decrease, respectively, the size of his/her wager accordingly. Optionally, a “max bet spin” button may be provided for automatically wagering a maximum number of credits and contemporaneously spinning the reels of the wagering game 530, as well as any of the buttons and meters displayed in FIG. 3.

The wagering game 530 is shown in FIG. 4 after play of a base game segment is initiated, for example, by the player providing a wager (e.g., responsive to an input via at least one input device), and thereafter pressing a spin button or pulling a spin lever. The monetary wager, which is typically a selected number of credits, is deducted from the available credits, e.g., the 2000 credits displayed via the CREDITS meter 584 in FIG. 4. The monetary wager or “bet” that is in play (e.g., 100 credits in FIG. 4) can be displayed via the BET meter 586. The reels 535-539 may then be varied (e.g., spun and stopped), and will continue to spin until they are stopped to reveal in the displayed array 532 reel symbols which represent a randomly selected outcome of the wagering game 530. The wagering-game outcome is, according to some aspects, randomly selected from a plurality of potential wagering-game outcomes. As indicated above, each outcome is evaluated for winning symbol combinations to determine if the displayed outcome has one or more awards associated therewith. In alternate embodiments, FIG. 4 can be representative of a bonus game segment of the wagering game 530.

A local controller (e.g., CPU 30 of FIG. 2), a host system (e.g., external system 48 of FIG. 2), a central controller, or any combination thereof, in alternative embodiments, operates to execute the wagering game program causing the display area 514 to display selected portions of the wagering game 530. An outcome of the wagering game 530, be it for a base portion, a bonus portion, a progressive portion, a community portion, or otherwise, can be randomly selected from a predetermined set of potential wagering-game outcomes, for example, using a local or remote random number generator (RNG). The wagering-game outcome is then revealed, displayed, or otherwise communicated to the player, for example, on a corresponding display device 514. The game screen 514 displays the wagering-game outcome by portraying the reels 535-539 spinning and stopping to reveal reel symbols arranged in a 3-row, 5-column matrix—i.e., symbol array 532. A winning combination occurs, for example, when the displayed symbols correspond to one or more of the winning symbol combinations listed in a predetermined pay table. In response to a winning outcome, a wagering-game prize (e.g., a monetary award of credits) associated with that winning outcome is conferred upon the player.

With continuing reference to FIG. 4, the secondary display device 516 provides a screen shot of a PRIZE VAULT award multiplier pool screen 534. The PRIZE VAULT award multiplier pool screen 534 presents a number of available wager levels 560-564, each of which is associated with a respective wager amount and a respective multiplier pool 550-554. By way of non-limiting example, a first wager level 560, labeled LEVEL 1 in FIG. 4, corresponds to a one (1) credit per payline wager amount, and is associated with a first award multiplier pool 550 comprising three award multipliers: 1×, 2× and 3×. In addition, a second wager level 561, labeled LEVEL 2 in FIG. 4, corresponds to a two (2) credit per payline wager amount, and is associated with a second award multiplier pool 551 comprising three award multipliers: 2×, 3× and 4×. Contrastingly, a third wager level 562, which is designated LEVEL 3, corresponds to a three (3) credit per payline wager amount and a third award multiplier pool 552 comprising four award multipliers: 4×, 5×, 6× and 7×. A fourth wager level 563, designated LEVEL 4, corresponds to a four (4) credit per payline wager amount and a fourth award multiplier pool 553 comprising four award multipliers: 5×, 6×, 7× and 8×. Lastly, a fifth wager level 564, labeled LEVEL 5 in FIG. 4, corresponds to a five (5) credit per payline wager amount and a fifth award multiplier pool 554 comprising six award multipliers: 7×, 8×, 9×, 10×, 11× and 12×.

As shown, each of the multiplier pools 550-554 includes a distinct set of award multipliers, while some of the multiplier pools 550-554 include more award multipliers than others. For some alternative embodiments, one or more of the multiplier pools 550-554 may comprise the same number of award multipliers while, in some implementations, one or more of the multiplier pools 550-554 may comprise the exact same award multipliers. It is also within the scope and spirit of this disclosure that the number of award multipliers in a given pool and/or the values of the award multipliers included in a given pool be randomly determined. Also, although shown as increasing linearly (e.g., 1×, 2× and 3×; 2×, 3× and 4×, etc.), the award multipliers in one or more of the multiplier pools can increase non-linearly.

In the illustrated example, the award multiplier pool screen 534 is continuously displayed during consecutive (or selected) plays of the wagering game 530. However, it may be desirable for some preferred implementations that an award multiplier pool screen 534 not be presented to the player, and the available wager levels 560-564 and their corresponding multiplier pools 550-564 not be displayed to the player during play of the wagering game 530. Optionally, a selected one or ones of the available wager levels 560-564 and/or their corresponding multiplier pools 550-564 and/or one or more of the corresponding award multipliers can be displayed at select times during play of the wagering game 530. The third display device 518 can be used to indicate that a particular wager level 560-564 is active or eligible by enlarging, flashing, setting off, or otherwise emphasizing the corresponding icon associated with each active wager level. Alternatively, the third display device 518 could be omitted altogether.

The available wager levels 560-564 can be segregated into groups of “low wager levels” and “high wager levels,” or “low wager levels,” “medium wager levels” and “high wager levels”. In this regard, the value of the minimum award multiplier in a multiplier pool corresponding to a wager level designated as a “high wager level” can be set to be greater than the credit value of the wager amount associated with that wager level. For instance, in FIG. 4 the minimum award multiplier in the fifth award multiplier pool 554 has a value (or “coefficient”) of seven (7×), which is greater than the five (5) credit per payline wager amount associated with the fifth award multiplier pool 554. Likewise, the minimum award multiplier in the fourth award multiplier pool 553 has a value of five (5×), which is greater than the four (4) credit per payline wager amount associated with that award multiplier pool 553, while the minimum award multiplier in the third award multiplier pool 552 has a value of four (4×), which is greater than the three (3) credit per payline wager amount associated with that multiplier pool 552. The illustrated embodiment also indicates that the maximum award multiplier in a multiplier pool corresponding to a wager level designated as a “high wager level” can be set to be significantly larger (e.g., two, three or four times larger) than the maximum award multiplier in a multiplier pool corresponding to a wager level designated as a “low wager level”. As one example, the maximum award multiplier in the fifth award multiplier pool 554 has a value of twelve (12×), which is four times larger than the maximum award multiplier of three (3×) in the first award multiplier pool 550 and three times larger than the maximum award multiplier of four (4×) in the second award multiplier pool 551.

In contrast, the value of the minimum award multiplier in a multiplier pool corresponding to a wager level designated as a “low wager level” can be set to be equal to the credit value of the wager amount associated with that wager level. In some non-limiting examples, the minimum award multiplier in the first award multiplier pool 550 of FIG. 4 has a value (or “coefficient”) of one (1×), which is equal to the one (1) credit per payline wager amount associated with the first award multiplier pool 550. The minimum award multiplier in the second award multiplier pool 551 has a value of two (2×), which is equal to the two (2) credit per payline wager amount associated with that multiplier pool 551. The illustrated embodiment also indicates that the maximum award multiplier in a multiplier pool corresponding to a wager level designated as a “low wager level” can be set to be less than or equal to the minimum award multiplier in a multiplier pool corresponding to a wager level designated as a “high wager level”. As one example, the maximum award multiplier in the first award multiplier pool 550 has a value of three (3×), which is less than the minimum award multiplier of four (4×) in the third award multiplier pool 552 and the minimum award multiplier of five (5×) in the fourth award multiplier pool 553.

It is desirable, for at least some of the disclosed embodiments, that the multiplier pools 550-554 be cooperatively configured such that the wagering game 530 has a predetermined payback percentage. In particular, the total number of award multipliers (overall or in each pool), the value of each award multiplier, the average value of the multipliers (overall or in each pool), the probability of occurrence of each multiplier, and/or the contribution of each multiplier (overall or in each pool) can be assigned in such a manner to provide a specific payback percentage to the individual multiplier pools and/or the wagering game as a whole. As indicated in FIG. 5, for example, the first award multiplier pool (shown in the second-to-leftmost column, to the right of the “multiplier” column) includes three multipliers—1×, 2× and 3×—with respective probabilities of occurrence of approximately 0.477, 0.409 and 0.114, and respective contributions of approximately 0.477, 0.818 and 0.341, providing a final payback percentage of approximately 90.0% for the first award multiplier pool. The second award multiplier pool (shown in the column to the right of the first award multiplier pool column) includes four multipliers—2×, 3×, 4× and 5×—with respective probabilities of occurrence of approximately 0.217, 0.370, 0.326 and 0.087, and respective contributions of approximately 0.435, 1.109, 1.304 and 0.435, providing a final payback percentage of approximately 90.3%. The third award multiplier pool (shown in the central column of FIG. 5 to the right of the second award multiplier pool column) includes four multipliers—4×, 5×, 6× and 7×—with respective probabilities of occurrence of approximately 0.353, 0.392, 0.216 and 0.039, and respective contributions of approximately 1.412, 1.961, 1.294 and 0.275, providing a final payback percentage of approximately 90.6%. The fourth award multiplier pool (shown to the right of the third award multiplier pool column) includes five multipliers—5×, 6×, 7×, 8× and 9×—with respective probabilities of occurrence of approximately 0.195, 0.268, 0.293, 0.195 and 0.049, and respective contributions of approximately 0.976, 1.610, 2.049, 1.561 and 0.439, providing a final payback percentage of approximately 91.22%. The fifth award multiplier pool (shown in the second-to-right-most column of FIG. 5, to the left of the “game payout” column) includes six multipliers—7×, 8×, 9×, 10×, 11× and 12×—with respective probabilities of occurrence of approximately 0.317, 0.317, 0.146, 0.146, 0.049 and 0.024, and respective contributions of approximately 2.220, 2.537, 1.317, 1.463, 0.537 and 0.293, providing a final payback percentage of 92.02%. In the illustrated embodiment, the award multipliers in the multiplier pools of FIG. 5 are cooperatively configured such that the wagering game has a predetermined payback percentage of approximately 91%. As can be seen from the above description, the award multipliers in the multiplier pools corresponding to “low wager levels”—e.g., the first and second award multiplier pools, provide payback percentages of 90.00% and 90.27%, respectively, which are lower than the payback percentages provided by the award multipliers in the multiplier pools corresponding to “high wager levels”—e.g., the third, fourth and fifth award multiplier pools, which provide payback percentages of 90.59%, 91.22 and 92.02%, respectively.

With reference back to the example of FIG. 4, contemporaneously when or after a player places a wager to initiate play of the wagering game 530, a determination is made, e.g., via a local controller, a host controller, a central controller, or any combination thereof, from the available wager levels 560-564, of what is the wager level of the received wager. According to the illustrated gaming terminal 510, there are at least 15 paylines available for activation by a player, each of which may correspond to one of the 15 markers on the on the left-hand side and one of the corresponding 15 markers on the right-hand side of the perimeter of the array 532. (For purposes of demonstration, the paylines 58 of FIG. 3 can be representative of what some of the paylines available in FIG. 4 might look like.) When placing a bet, the player may decide to activate three paylines—e.g., one that extends horizontally through each of the three rows in the array 532—by placing a four-credit wager on each payline, for a total bet of 12 credits. Since the player is wagering four credits per payline, it can be determined in this example that the wager level of the received wager corresponds to the fourth wager level 563. In optional configurations, a separate wager level can be designated for each of the activated paylines, especially in scenarios where the credit amount wagered per payline is different.

Optional embodiments may associate each of the wager levels 560-564 with a respective plurality of available multiplier pools, with each pool comprising a distinct set of award multipliers. For such configurations, once the wager level is identified, an additional determination may be conducted to select which of the available multiplier pools will correspond to the wager level associated with the received wager in the subsequent play of the wagering game. Continuing with the above example, the fourth wager level 563, which corresponds to a four (4) credit per payline wager amount, may be associated with two available award multiplier pools: Multiplier Pool A, comprising four award multipliers: 5×, 6×, 7× and 8×; and Multiplier Pool B, comprising four award multipliers: 5×, 6×, 8× and 10×. After it is determined that the wager level of the received wager corresponds to fourth wager level 563, one or more processors may run a random determination to select whether Multiplier Pool A or Multiplier Pool B will be designated as the multiplier pool for the subsequent play of the wagering game 530.

Once the wager level is identified and, for some implementations, the appropriate award multiplier pool is designated, an award multiplier is randomly determined or selected from the multiplier pool corresponding to the determined wager level of the received wager. By way of explanation, and not limitation, the wagering game machine 510 may include a random number generator (RNG) for generating a random number, game logic for selecting one of the award multipliers in the fourth award multiplier pool 553 based on the randomly generated number, and, optionally, game assets (e.g., art, sound, etc.) for presenting the determined award multiplier to a player in an audio-visual manner. For some preferred embodiments, the random determination of the award multiplier is independent of the random determination of the outcome of the wagering game 530. As an extension of this concept, randomly determining the award multiplier can be wholly separate and distinct from the wagering-game outcome. Moreover, randomly determining the award multiplier can be conducted prior to (or after) randomly determining the outcome of the wagering game 530. In embodiments where a separate wager level is designated for each of the activated paylines, a separate random determination can be made for each wager level and/or each payline to identify an award multiplier for the payline(s) associated with that wager level.

Prior to, contemporaneously with, or after randomly selecting the award multiplier(s) for the received wager, an outcome of the wagering game 530 is randomly determined. This step can be conducted in any known manner, including those disclosed herein. The award multiplier or multipliers is/are then applied to the outcome of the wagering game 530. Applying an award multiplier can include multiplying an award value associated with a winning symbol combination aligned on an active payline in the wagering game outcome by the randomly determined award multiplier. Continuing with the above example, the RNG and game logic may randomly select the 6× award multiplier from the fourth award multiplier pool 553. The randomly determined wagering-game outcome may include, for example, three SHIP symbols 547 aligned on one of the three active paylines and four ZEUS symbols 545 aligned on another active payline. The three-SHIP-symbol winning combination may have an award value of 10 credits in accordance with a predetermined pay table, whereas the four-ZEUS-symbol winning combination may have an award value of 100 credits in accordance with the pay table. With the 6× award multiplier that has been randomly selected, the total credit award to the player is ((100×6)+(10×6)) credits, for a total of six-hundred and sixty (660) credits. This total credit award is significantly higher than the four-hundred and forty (44) credits that would be awarded with a traditional slot machine, which would automatically set the award multiplier to be equal to the wager amount placed on the paylines (e.g., 4× for the four-credit wager placed by the player on each payline).

The award multiplier may be displayed or emphasized to the player if the outcome of the wagering game includes at least one winning symbol combination. For some optional configurations, the award multiplier may be displayed or emphasized to the player for only select winning outcomes (e.g., those where the total award value is greater than the total wager amount). Alternatively, for wins where the total award is less than the total wager, the award multiplier may not be displayed or may be quickly displayed or flashed. Conversely, for the large or largest wins, such as those that may only occur every 80 or 100 plays of the wagering game, the presentation of the award multiplier can be more dramatic and visually striking.

For some implementations, contrary to some prior art configurations, the award values listed in a game's pay table do not automatically multiply as a player's bet increases. Alternatively, the award values listed in a game's pay table increase incrementally or include predetermined “kicker” pays as a player's bet increases. Also, a randomly determined award multiplier selected from a multiplier pool could be applied to a series of games, for example, where a player is allowed to purchase a series games (known as “block wagering”) at the same bet level. In some embodiments, if there is a bonus event, one preferred method includes completing the bonus event, adding any bonus award credits to the base game award credits, and then multiplying the total award credits by a randomly selected award multiplier. Optionally, each award achieved throughout a bonus event (e.g., each spin of a free-spin bonus slot game, or each round of a player pick bonus game) is multiplied by a randomly selected multiplier from the corresponding pool would.

With reference now to the flow chart of FIG. 6, an improved method for conducting a wagering game on a gaming terminal and/or a gaming system, such as those shown in FIGS. 1-5, for example, is generally described at 600 in accordance with aspects of the present disclosure. FIG. 6 can be representative of an algorithm that corresponds to at least some instructions that can be stored, for example, in main memory 32 of FIG. 2, and executed, for example, by the CPU 30 and/or external system(s) 48 of FIG. 2 to perform any or all of the above or below described functions associated with the disclosed concepts. The method 600 will be described with reference to the various aspects and features shown in FIGS. 4 and 5 of the drawings; such reference is being provided purely by way of explanation and clarification.

The method 600 starts at block 601 with providing a wagering game that includes a number of symbol-bearing reels, each of which has a plurality of distinct reel positions populated by various symbols. Examples of such a wagering game, including an assortment of features, options and alternatives that may be incorporated into the method 600, have been described in extensive detail hereinabove with reference to FIGS. 1-5. FIG. 4, for example, presents a slot-type wagering game 530 which includes a plurality of symbol-bearing reels 535-539 each having a plurality of distinct reel positions populated by symbols.

At block 603, the method 600 further comprises providing a plurality of available wager levels, each of which corresponds to a respective wager amount and a respective multiplier pool. Each of the multiplier pools includes a plurality of award multipliers. The PRIZE VAULT award multiplier pool screen 534 shown in FIG. 4 presents a number of representative wager levels 560-564, each of which is associated with a representative wager amount and a representative multiplier pool 550-554. As indicated above, each of the multiplier pools 550-554 may include a distinct set of award multipliers, while some of the multiplier pools 550-554 may include more award multipliers than others.

The method 600 continues to block 605 with receiving (e.g., via an input device such as touch screen 18, bill validator 22, information reader/writer 24, etc.) an indication of a wager to play the wagering game. At block 607, the wager level of the received wager is determined. For example, a one (1) credit per payline wager amount may correspond to the first wager level 560, a two (2) credit per payline wager amount may correspond to the second wager level 561, a three (3) credit per payline wager amount may correspond to the third wager level 562, a four (4) credit per payline wager amount may correspond to the fourth wager level 563, whereas a five (5) credit per payline wager amount may correspond to the fifth wager level 564. As indicated above, a separate wager level can be designated for each of the activated paylines, especially in situations where the credit amount wagered per payline is different.

For block 609, an award multiplier is randomly determined or selected from the multiplier pool corresponding to the determined wager level of the received wager. This may include an RNG generating a random number, and game logic selecting one of the award multipliers in the corresponding award multiplier pool based on the randomly generated number, as described above. If a separate wager level was designated for each of the activated paylines, a separate random determination can be conducted for each wager level or each payline to identify an award multiplier for the payline associated with that wager level.

At block 611, an outcome of a base-game portion (or, alternatively, a bonus-game portion, a progressive-game portion, a community-game portion, etc.) of the wagering game is randomly determined. This may include, as indicated above, an RNG generating a random number, game logic for determining the outcome based on the randomly generated number, and the CPU 30, the external system 48, or both, in alternative embodiments, operating to execute a wagering game program, and game assets (e.g., art, sound, etc.) for presenting the determined outcome to a player in a visual manner. For block 613, the award multiplier or multipliers is/are applied to the outcome of the wagering game.

The method 600 then displays the outcome of the wagering game to the player at block 615. The base-game outcome of the wagering game can be visually represented by a plurality of symbols arranged on a display device, such as the symbols on the slot reels 535-539 that are arranged in the symbol array 532 of FIG. 4. Block 615 then requires determining whether there is an award associated with the displayed outcome of the wagering game.

In some embodiments, the method 600 includes at least those steps enumerated above. It is also within the scope and spirit of the present invention to omit steps, include additional steps, and/or modify the order presented above. It should be further noted that the method 600 illustrated in FIG. 6 can be representative of a single sequence for playing a wagering game. However, it is expected that the method 600 will be practiced in a systematic and repetitive manner.

Aspects of this disclosure can be implemented, in some embodiments, through a computer-executable program of instructions, such as program modules, generally referred to as software applications or application programs executed by a computer. The software can include, in non-limiting examples, routines, programs, objects, components, and data structures that perform particular tasks or implement particular abstract data types. The software can form an interface to allow a computer to react according to a source of input. The software can also cooperate with other code segments to initiate a variety of tasks in response to data received in conjunction with the source of the received data. The software can be stored on any of a variety of memory media, such as CD-ROM, magnetic disk, bubble memory, and semiconductor memory (e.g., various types of RAM or ROM).

Moreover, aspects of the present disclosure can be practiced with a variety of computer-system and computer-network configurations, including hand-held devices, multiprocessor systems, microprocessor-based or programmable-consumer electronics, minicomputers, mainframe computers, and the like. In addition, aspects of the present disclosure can be practiced in distributed-computing environments where tasks are performed by remote-processing devices that are linked through a communications network. In a distributed-computing environment, program modules can be located in both local and remote computer-storage media including memory storage devices. Aspects of the present disclosure can therefore, be implemented in connection with various hardware, software or a combination thereof, in a computer system or other processing system.

Any of the methods described herein can include machine readable instructions for execution by: (a) a processor, (b) a controller, and/or (c) any other suitable processing device. Any algorithm, software, or method disclosed herein can be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it can be implemented by an application specific integrated circuit (ASIC), a programmable logic device (PLD), a field programmable logic device (FPLD), discrete logic, etc.). Also, some or all of the machine readable instructions represented in any flowchart depicted herein can be implemented manually. Further, although specific algorithms are described with reference to flowcharts depicted herein, persons of ordinary skill in the art will readily appreciate that many other methods of implementing the example machine readable instructions can alternatively be used. For example, the order of execution of the blocks can be changed, and/or some of the blocks described can be changed, eliminated, or combined.

It should be noted that the algorithms illustrated and discussed herein as having various modules or blocks or steps that perform particular functions and interact with one another are provided purely for the sake of illustration and explanation. It should be understood that these modules are merely segregated based on their function for the sake of description and represent computer hardware and/or executable software code which can be stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While many embodiments and modes for carrying out the present invention have been described in detail above, those familiar with the art to which this invention relates will recognize various alternative designs and embodiments for practicing the invention within the scope of the appended claims.

What is claimed is:

1. A gaming system for conducting a wagering game, the gaming system comprising:
one or more processors; and
one or more memory devices storing instructions that, when executed by at least one of the one or more processors, cause the gaming system to:
receive an indication of a wager to play the wagering game, the wagering game including a plurality of available wager levels, each of the wager levels corresponding to a respective wager amount and a respective multiplier pool, each of the multiplier pools including a plurality of award multipliers;
determine, from the available wager levels, a wager level of the received wager;
randomly determine, from the respective multiplier pool corresponding to the determined wager level of the received wager, an award multiplier;
randomly determine an outcome of the wagering game; and
apply the award multiplier to the outcome of the wagering game.

2. The gaming system of claim 1, wherein each of the multiplier pools includes a distinct plurality of award multipliers.

3. The gaming system of claim 1, wherein each of the award multipliers in at least one of the multiplier pools has a respective probability of being randomly determined as the award multiplier.

4. The gaming system of claim 1, wherein the applying the award multiplier includes multiplying an award value associated with a winning symbol combination aligned on an active payline in the wagering game outcome by the randomly determined award multiplier.

5. The gaming system of claim 1, wherein each of the wager levels is associated with a respective plurality of available multiplier pools, and wherein the one or more memory devices store additional instructions that cause the gaming system to determine, from the respective plurality of available multiplier pools, the respective multiplier pool corresponding to the wager level associated with the received wager.

6. The gaming system of claim 1, wherein the randomly determining the award multiplier is independent of the randomly determining the outcome of the wagering game.

7. The gaming system of claim 1, wherein the randomly determining the award multiplier is prior to the randomly determining the outcome of the wagering game.

8. The gaming system of claim 1, wherein the one or more memory devices store additional instructions that cause the gaming system to display the award multiplier if the outcome of the wagering game includes at least one winning symbol combination.

9. The gaming system of claim 1, wherein the plurality of available wager levels includes at least one low wager level and at least one high wager level, a value of a minimum award multiplier in the multiplier pool corresponding to the at least one high wager level being greater than a credit value of the wager amount associated with the at least one high wager level.

10. The gaming system of claim 9, wherein a value of a minimum award multiplier in the multiplier pool corresponding to the at least one low wager level equals a credit value of the wager amount associated with the at least one low wager level.

11. The gaming system of claim 1, wherein the plurality of available wager levels includes at least one low wager level and at least one high wager level, wherein the plurality of award multipliers included in the multiplier pool associated with the at least one low wager level provide a first payback percentage in the wagering game, and the plurality of award multipliers included in the multiplier pool associated with the at least one high wager level provide a second payback percentage in the wagering game which is higher than the first payback percentage.

12. The gaming system of claim 1, wherein the award multipliers assigned to the multiplier pools are cooperatively configured such that the wagering game has a predetermined payback percentage.

13. The gaming system of claim 1, wherein the randomly determined award multiplier is a minimum multiplier applied to the outcome of the wagering game.

14. One or more non-transitory computer-readable storage media including instructions which, when executed by one or more processors, cause the one or more processors to perform operations comprising:
receive an indication of a wager to play a wagering game, the wagering game including a plurality of available wager levels, each of the wager levels corresponding to a respective wager amount and a respective multiplier pool, each of the multiplier pools including a plurality of award multipliers;
determine, from the available wager levels, a wager level of the received wager;
randomly determine, from the respective multiplier pool corresponding to the wager level associated with the received wager, an award multiplier;
randomly determine an outcome of the wagering game; and
apply the award multiplier to the outcome of the wagering game.

15. A method of conducting a wagering game with a gaming system having one or more input devices, one or more display devices, and one or more processors, the method comprising:
receiving, via at least one of the one or more input devices, an indication of a wager to play the wagering game, the wagering game including a plurality of available wager levels, each of the wager levels corresponding to a respective wager amount and a respective multiplier pool, each of the multiplier pools including a plurality of award multipliers;
determining, from the available wager levels, a wager level of the received wager;
randomly determining, via at least one of the one or more processors from the respective multiplier pool corresponding to the wager level associated with the received wager, an award multiplier;
randomly determining, via at least one of the one or more processors, an outcome of the wagering game;
applying the award multiplier to the outcome of the wagering game; and
displaying, via at least one of the one or more display devices, the randomly determined wagering game outcome.

16. The method of claim 15, wherein each of the multiplier pools includes a distinct plurality of award multipliers.

17. The method of claim 15, wherein each of the award multipliers in at least one of the multiplier pools has a distinct probability of being randomly determined as the award multiplier.

18. The method of claim 15, wherein the applying the award multiplier includes multiplying an award value associated with a winning symbol combination aligned on an active payline in the wagering game outcome by the randomly determined award multiplier.

19. The method of claim 15, wherein the randomly determining the award multiplier is independent of the randomly determining the outcome of the wagering game.

20. The method of claim 15, wherein the plurality of available wager levels includes at least one low wager level and at least one high wager level, a value of a minimum award multiplier included in the multiplier pool of the at least one low wager level equals a value of the wager amount associated with the at least one low wager level, and a value of a minimum award multiplier included in the multiplier pool of the at least one high wager level being greater than a value of the wager amount associated with the at least one high wager level.
